(19) United States
(12) Patent Application Publication
(10) Pub. No.: US 2008/0155068 A1
(43) Pub. Date: Jun. 26, 2008

(54) SUPPORT FOR SHARING ABSTRACT APPLICATIONS

(75) Inventors: Mark W. Newman, San Francisco, CA (US); Kurt E. Partridge, Palo Alto, CA (US); Ame M. Elliott, San Francisco, CA (US); James M. A. Begole, San Jose, CA (US); Sang-Do Park, Gyeonggi-Do (KR); Jun-Hyeong Kim, Suwon (KR)

Correspondence Address: MARGER JOHNSON & MCCOLLOM/PARC, 210 MORRISON STREET, SUITE 400, PORTLAND, OR, 97204, US

(73) Assignees: PALO ALTO RESEARCH CENTER INCORPORATED, Palo Alto, CA (US); SAMSUNG ELECTRONICS CO., LTD., Gyeonggi-do (KR)

(21) Appl. No.: 11/614,663

(22) Filed: Dec. 21, 2006

(51) Int. Cl. G06F 15/177

(52) U.S. Cl. 709/220

(57) ABSTRACT

A computer-controlled method to configure a network of devices acquires a specific instance of an abstract application of at least one component in a first network, captures and stores fields of the component in the abstract application, classifies the fields as to how the fields are to be used in matching, provides field values for fields within each component to be used in matching, and store the fields, components and values as a general instance of the abstract application. An apparatus has an acquisition mechanism to acquire a specific instance of an abstract application of at least one component in a first network, a generalization mechanism to identify and generalize fields and values associated with the component, and a store to store the fields, components and values as a general instance of the abstract application. A computer-controlled method to configure a network of devices receives, at a network, a general instance of an abstract application having fields of at least one component and fields having values, identifies at least one component in the network having at least one of the fields in the general instance, and using the fields and values to resolve the general instance into a specific instance of the abstract application in the network. An apparatus has a discovery mechanism for discovering a generalized instance of an abstract application, the abstract application having at least one component having fields and the fields having values, and an importation mechanism to identify a component in the network having at least one of the fields in the general instance and to use the fields and values to resolve the general instance into a specific instance of the abstract application in the network.

### CROSS-REFERENCE TO RELATED APPLICATIONS

This application is related to the following U.S. patent applications, incorporated by reference herein in their entirety:

U.S. patent application Ser. No. 10/317,764, filed Dec. 12, 2002, “Methods, Apparatus, and Program Products for Abstract Applications/Components in a Ubiquitous Computing Environment;”

U.S. patent application Ser. No. 10/317,621, filed Dec. 12, 2002, “Methods, Apparatus, and Program Products for Analyzing Context in a Networked Computing Environment;’

U.S. patent application Ser. No. 10/317,342, filed Dec. 12, 2002, “Methods, Apparatus, and Program Products for Configuring Components in Networked Computing Environments;” and

U.S. patent application Ser. No. 10/317,580, filed Dec. 12, 2002, “Methods, Apparatus, and Program Products for Utilizing Contextual Property Metadata in Network Computing Environments.”

### GOVERNMENT FUNDING

This invention was made with Government support under Cooperative Agreement No. 70NAB3H3052 awarded by the National Institute of Standards and Technology. The Government has certain rights in this invention.

### BACKGROUND

Sophisticated network users, including users of home networks, may create scripts or programs to have the devices in that user's network perform a particular task or set of tasks. This user then may enact a pattern of sharing functionality by providing the script, program, or a textual description, referred to here as information, to other users. The user may post the information on a web site, private or public electronic bulletin board, e-mail it to others, or transfer it to a physical memory component such as a floppy diskette, a compact disc, ‘thumb’ drive and use the ‘sneaker net’ to transfer it to other users.

Another user may then take the script or program and adapt it for the other user's needs. This may involve editing or otherwise manipulating the information to fit the needs and configuration of the other user's network and the other user's devices on that network. The other user's network may have devices, such as cameras, displays, printers, etc., that provide the other use with similar functionality, but are not the same type of components as the first user.

This requires a relatively high level of sophistication. The first user must have the knowledge to describe or otherwise document the configuration program or script with enough detail that someone can understand the function being described. The other user wanting to employ the configuration script or program must also have a level of sophistication that allows the other user to adapt the script to that user's network and devices on the network.

### SUMMARY

An embodiment is a computer-controlled method to configure a network of devices that acquires a specific instance of an abstract application of at least one component in a first network, captures and stores fields of the component in the abstract application, classifies the fields as to how the fields are to be used in matching, provides field values for fields within each component to be used in matching, and store the fields, components and values as a general instance of the abstract application.

Another embodiment is an apparatus that has an acquisition mechanism to acquire a specific instance of an abstract application of at least one component in a first network, a generalization mechanism to identify and generalize fields and values associated with the component, and a store to store the fields, components and values as a general instance of the abstract application.

Another embodiment is computer-controlled method to configure a network of devices that receives, at a network, a general instance of an abstract application having fields of at least one component and fields having values, identifies at least one component in the network having at least one of the fields in the general instance, and using the fields and values to resolve the general instance into a specific instance of the abstract application in the network.

Another embodiment is an apparatus that has a discovery mechanism for discovering a generalized instance of an abstract application, the abstract application having at least one component having fields and the fields having values, and an importation mechanism to identify a component in the network having at least one of the fields in the general instance and to use the fields and values to resolve the general instance into a specific instance of the abstract application in the network.

### BRIEF DESCRIPTION OF THE DRAWINGS

Embodiments of the invention may be best understood by reading the disclosure with reference to the drawings, wherein:

FIG. 1 shows an example of a pattern of sharing abstract applications.

FIG. 2 shows an example of a specific instance of an abstract application in a first network.

FIG. 3 shows an example of a general instance of a specific instance of an abstract application in a first network.

FIG. 4 shows an example of a general instance of an abstract application having field descriptors tagged with importance descriptors.

FIG. 5 shows an example of resolution of a general instance into a specific instance in a second network.

### DETAILED DESCRIPTION OF THE EMBODIMENTS

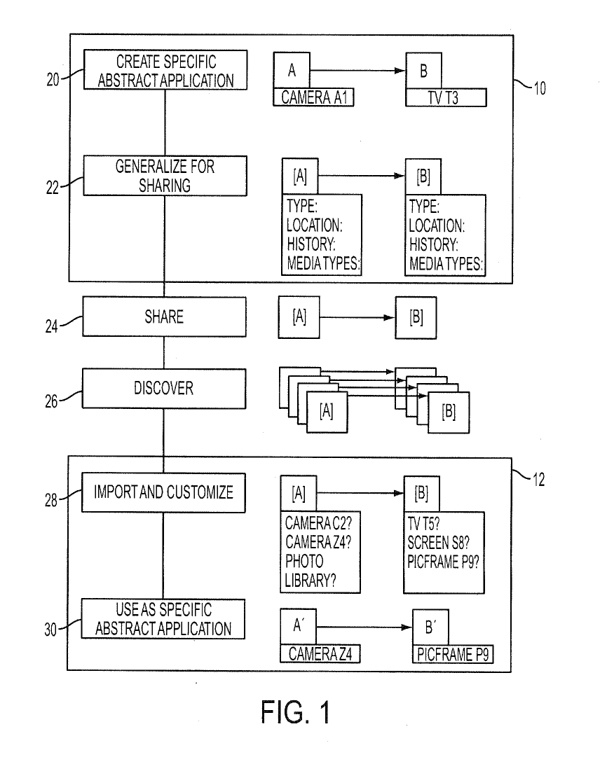

FIG. 1 shows an example of a pattern of sharing abstract applications. A first user has a network or environment 10, having a source device A and a destination device B. The user would create an abstract application, either explicitly or implicitly, to execute some network relationship between the devices A and B. As used here, a network relationship may be a configuration or a connection, such as connecting a particular camera to a display device B.

A user could explicitly create an abstract application by intending to create a file or other storage, such as an XML file, that characterizes or documents a connection between two devices to perform some task or to relate to each other in a particular way. The user may implicitly create an abstract application by configuring the devices to talk to each other, and the system would create the abstract application automatically, or transparently to the user.

An abstract application allows components on a network to form associations with one another, referred to here as “configurations,” and to execute operations that combine to provide some functionality to a user or another computer system. In a simple form, an abstract application contains sufficiently detailed information such that when the abstract application is used, it recreates a previously used component configuration. In a more general form, an abstract application allows a new component configuration to be created, based on aspects of the current context of use that has a similar functionality to a previously used configuration. Abstract applications may be saved as files, in component context, in searchable databases or file structures. The embodiments discussed here provide mechanisms to allow users with considerably less training and skill to both share and receive network configurations, and provides an advantage over the current approaches.

Once the specific instance of the network relationship, the abstract application, is acquired at 20, a generalization mechanism may generalize it for sharing at 22. Acquiring an abstract application may involve mechanisms for discovering the abstract application, receiving it from another user, or from the system that generated it automatically, as well a creating one. Generalizing for sharing will be discussed in more detail later, but a generalizing mechanism may identify fields of the components involved in the abstract application, and providing values for fields that describe those components.

At 24, A decides to share the general instance of the abstract application, and at 26, the targeted user or users discover the generalized instance. User B has a second environment or network 12 in which the abstract application will be used. At 28, the general instance is imported and the components corresponding to the general fields of the components specified at 22 are identified. Values, or flags, for the various fields of the components are evaluated and resolved into selection of a camera and a display device, in the example used above. At 30, the local instance of the network relationship, or abstract application, is then employed in the second network.

For case of understanding and to provide a concrete example of such sharing, the example of a first user configuring a camera to display images on a particular display device being generalized and then imported to another network will be discussed. No intention of limiting the scope of the claims to such a specific example is intended and none should be inferred.

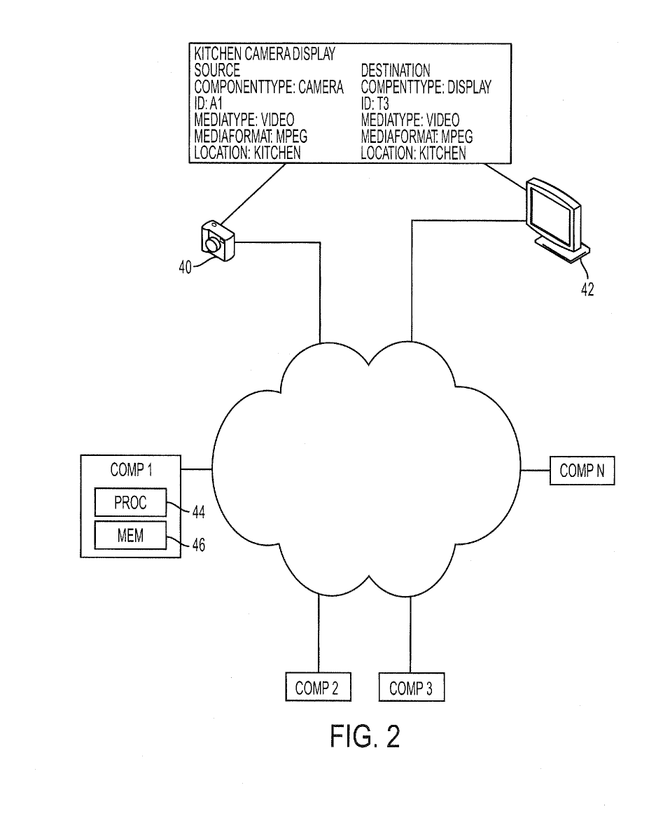

The networks discussed here may include any combination of devices and services that communicate, and may have anywhere from one device to as many devices as a user desires. The environment may have a network administration device such as a server or computer, or any device on the network may act as the importing system. The methods of the embodiments discussed herein may be controlled by the network device importing or exporting the abstract application. The device that is responsible for importing or exporting the abstract application may be referred to here as a computer. The reference to a computer, such as COMP1 in FIG. 2, merely defines a device that has some sort of processor 44, microcontroller, etc. that can execute instructions that may be stored in a memory 46. References to a computer-controlled method may also refer to any ‘computer’ that can execute the processes in the method.

In FIG. 2, a first environment is a home network having a camera 40 and a display device 42, as well as other components COMP 1 through COMP N. This first environment provides the specific or local instance of the abstract application. While the connection shown is through a network, the connections could also be directly wired or linked wirelessly, such as by connections complying with various standards, including Bluetooth, infrared, IEEE 1394 ‘firewire,’ Ethernet, and connection in accordance with the various IEEE 802.11x wireless standards. This particular application will be referred to here as ‘Kitchen Camera Display.’ The abstract application includes the involved components, and each component description has fields. As used here, a field is a component-level descriptor that identifies an attribute such as name, ID, media types provided or accepted, model number, etc., of a particular component. Examples of components include a camera, a display device, a service such as a web site, etc. The fields may be annotated with information that describes how the fields are to be used for later matching. For example, a field may be marked as ‘absolute,’ meaning that is refers to a component that should not be changed to match something in the second environment, but should be accessed in the same manner by abstract applications instantiated in both the first and second environments.

Fields may also be marked with a high or low priority indicating that the first user or first system believes that a particular field is important or unimportant to consider when finding a match in the new environment. A field may also be marked as ‘linked’ with a different field within the same abstract component description or a different abstract component description within the same abstract application. An example may include having two components that share a same location, such as the camera and the display should both be in the kitchen.

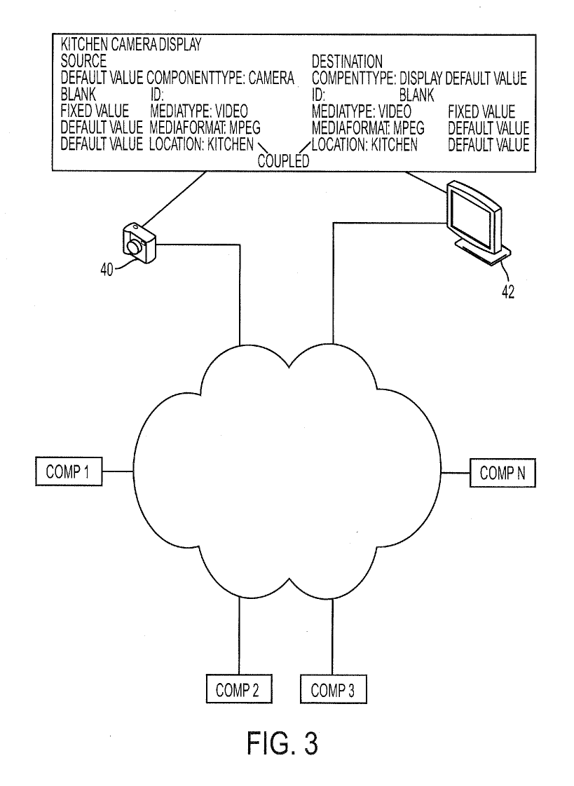

FIG. 3 shows an example of a generalization of the abstract application ‘Kitchen Camera Display.’ In this example, the source is a camera and the destination is a display. The component fields have been further defined for generalization with field descriptors. The component fields will typically have values, referred to here as field values. An example in FIG. 3 is the component field ComponentType having a field value of Camera.

The information about how the fields should be used in importation is recorded in field descriptors. The actual value of the field descriptor will be referred to as field descriptor values. A particular type of field descriptor is an importance descriptor, which will have an importance descriptor value such as ‘high’ or ‘low’. The ComponentType field has a field descriptor value of ‘default value.’

In the example, the field descriptors have field descriptor values of ‘default,’ ‘blank,’ and ‘fixed.’ The ‘default’ field descriptor value indicates that the first user or environment recommends or believes that the value of the field to be whatever the value is, but that the second user or environment can override it. The ‘blank’ field descriptor value indicates that the first user is not sharing the specific values he or she specified in the local instance of the abstract application. The field descriptor value ‘fixed’ indicates that the value should not be changed. Further, field descriptors may also identify the fields as ‘linked,’ meaning that that field value for the source and destination should be the same. The field descriptors could be implemented in name-value pairs, such as ‘absolute’ as the name and the value being ‘true’ or ‘false.’ Alternatively, the field descriptors could be implemented as flags, with the value defined by the presence or absence of flags. Both field descriptor values and flags will be referred to as field descriptor values.

In the example of the kitchen camera and display, the field descriptor values for the source show that the component type of camera and the media format of MPEG (Moving Pictures Experts Group) are default values, meaning that they may be overridden. The media type of video is a fixed value, meaning that it should not be changed.

The field descriptor for location is a default value, meaning that it can be overridden. The field descriptor for location is also coupled, so that the source and destination values for these fields should be the same.

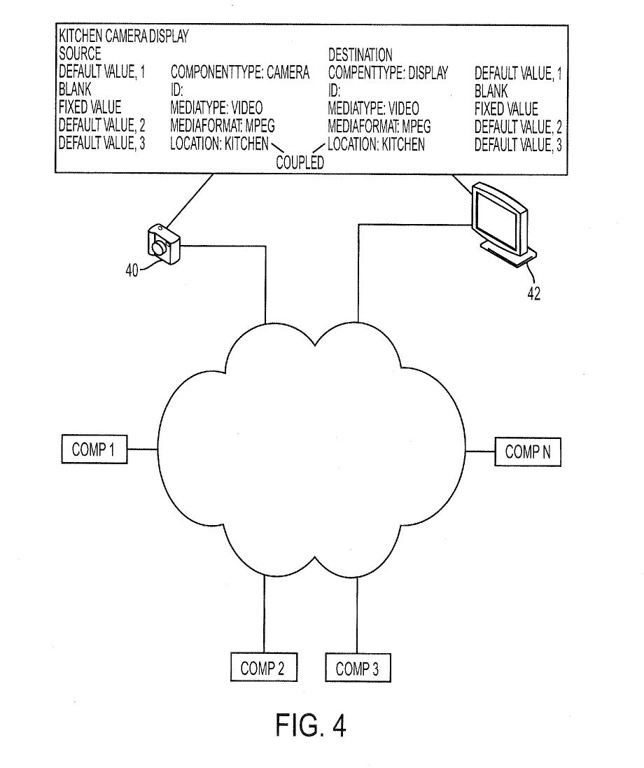

Other field descriptors may also be possible. In one embodiment, the importance of fields in finding a matching value between the exporting and importing environments. One embodiment may use a constraint resolution approach, the system would attempt to preserve any default values as possible, using importance descriptors to decide the order in which defaults may be overridden. In the example of FIG. 4, the generalized instance of FIG. 3 now has importance values. In the example, the lower numbers mean more importance and therefore stronger preservation of the default values.

In the example of FIG. 4, the ComponentType field has an importance value of 1, indicating that the preservation of this field and its default value should weigh more than the preservation of Location. In turn, the preservation of Location should weigh more than the preservation of MediaFormat. Further, the linked descriptor on the Location fields would weigh the same as the ComponentType, and stronger than the actual default values of the location. This indicates that the exporting user finds most important that the abstract application is for a camera and a display in the same location, and that the actual location is less important, but typically a kitchen. In actuality, the implementation of this abstract application would allow other ComponentType values, as long as they are of MediaType=Video, because that field descriptor indicates a fixed value.

Having provided the general instance of the abstract application shown in FIGS. 3 and 4, the discussion now turns to discussion of the importation of the general instance into a second environment or network. This presents one possible example of such an importation and no limitation to any particular embodiment is intended.

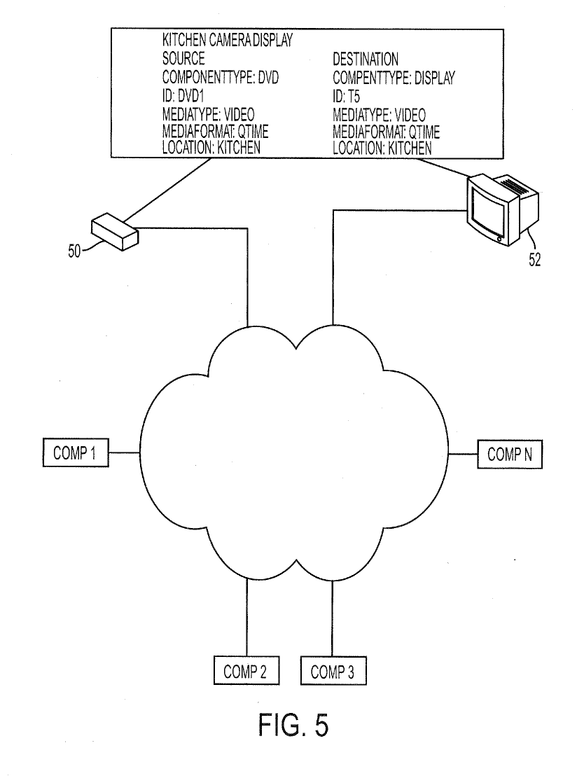

In FIG. 5, one can see that the source is now a DVD player 50, with ComponentType DVD. Referring back to FIG. 4, one can see that the field value for MediaType was resolved first because it was a fixed value. In this particular resolution, then, the system located the component that has the proper media type of video, which turned out to be a DVD player. The importing system then resolved the fields in order of importance, the first of which was the location being the kitchen. The component selected was the DVD player, having a video media type located in the kitchen. The default value of MPEG for the media format was overridden in favor of QuickTime®. Similarly, for the source, the display T5 52 has the proper media type, located in the kitchen, with the ability to display QuickTime® video.

In addition to having the ability to import and export abstract applications as configurations, it is also possible to manage connections and components. Up until this point, the discussion has centered on configurations having one connection between two components and how that connection may be generalized and imported. In addition, it is possible to nest generalizations of the connections within an abstract application. In one embodiment, a connection or component may be designated as ‘required’ in order for a particular abstract application to be used. An embodiment may also designate that any connection not designated as ‘required’ becomes ‘optional’ by default.

For example, a user may have a specific instance of an abstract application that involves four devices, A, B, C and D. When that instance is generalized for sharing, the components may be designated as required or optional. For example, components A, B and C are required and D is optional. When the importing network attempts to import the abstract application, the importation process will try to find equivalents of all four components, but will still operate if component D is missing. If any component A, B, or C is missing, the abstract application will not work.

Within a Connection field, a fixed value implies a required field, as in the abstract application discussion above. The importing system would interpret this field as necessarily available for the system to successfully import and use the abstract application, meaning that the second environment must have devices or services that have the capability to make the connection.

For example, a video conference abstract application may designate audio connections as required, such as a microphone and speaker(s) must be available, while allowing video connections to be optional. A first example of an abstract application having such a required connection is shown below.

Abstract Application: Video Phone Call
Connection No.: 1
Connection Name: Audio from Caller to Recipient
Required: True

| Component A | | | | Component B | | | |
|---|---|---|---|---|---|---|---|
| Field Name | Field Value | Flags | Priority | Field Name | Field Value | Flags | Priority |
| Type | Microphone | Default | 1 | Type | Speakers | Default | 1 |
| ID | | Blank | | ID | | Blank | |
| MediaType | Audio | fixed | | MediaType | Audio | Fixed | |
| MediaFormat | Mu law | Default, | 2 | MediaFormat | Mu law | Default, | 2 |
| | | linked | | | | linked | |
| Location | Same as caller | Fixed | | Location | Same as | Fixed | |
| | | | | | recipient | | |

Linked fields: A. MediaFormat, B. MediaFormat

Connection No.: 2
Connection Name: Audio from Recipient to Caller
Required: True

| Component C | | | | Component D | | | |
|---|---|---|---|---|---|---|---|
| Field Name | Field Value | Flags | Priority | Field Name | Field Value | Flags | Priority |
| Type | Microphone | Default | 1 | Type | Speakers | Default | 1 |
| ID | | Blank | | ID | | Blank | |
| MediaType | Audio | fixed | | MediaType | Audio | Fixed | |
| MediaFormat | Mu law | Default, | 2 | MediaFormat | Mu law | Default, | 2 |
| | | linked | | | | linked | |
| Location | Same | Fixed | | Location | Same as | Fixed | |
| | as recipient | | | | caller | | |

Linked fields: C. MediaFormat, D. MediaFormat

Connection No.: 3
Connection Name: Video from Caller to Recipient
Required: False

| Component E | | | | Component F | | | |
|---|---|---|---|---|---|---|---|
| Field Name | Field Value | Flags | Priority | Field Name | Field Value | Flags | Priority |
| Type | Video camera | Default | 1 | Type | Display | Default | 1 |
| ID | | Blank | | ID | | Blank | |
| MediaType | Video | fixed | | MediaType | Video | Fixed | |
| MediaFormat | MPEG-2 | Default, | 2 | MediaFormat | MPEG-2 | Default, | 2 |
| | | linked | | | | linked | |
| Location | Same as caller | Fixed | | Location | Same as | Fixed | |
| | | | | | recipient | | |

Linked fields: E. MediaFormat, F. MediaFormat

Connection No.: 4
Connection Name: Video from Recipient to Caller
Required: False

| Component G | | | | Component H | | | |
|---|---|---|---|---|---|---|---|
| Field Name | Field Value | Flags | Priority | Field Name | Field Value | Flags | Priority |
| Type | Video camera | Default | 1 | Type | Display | Default | 1 |
| ID | | Blank | | ID | | Blank | |
| MediaType | Video | fixed | | MediaType | Video | Fixed | |
| MediaFormat | MPEG-2 | Default, | 2 | MediaFormat | MPEG-2 | Default, | 2 |
| | | linked | | | | linked | |
| Location | Same as | Fixed | | Location | Same as | Fixed | |
| | recipient | | | | caller | | |

Linked fields: G. MediaFormat, H. MediaFormat

The generalization of connections further allows for importation of abstract applications that will function in the second environment. By designating connections that are necessary in the second environment, the probability of success of importation is increased.

In this manner, then, a specific instance of an abstract application is generalized in a first environment. As an optional process, the generalization may include importance descriptors to add an importing system in resolving the general instance. The general instance may also include configuration of connections. The general instance is then imported into a second environment and resolved into a second specific instance.

It will be appreciated that several of the above-disclosed and other fields and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A computer-controlled method to configure a network of devices, comprising:
acquiring a specific instance of an abstract application of at least one component in a first network;
capturing and storing fields of the component in the abstract application;
classifying the fields as to how the fields are to be used in matching;
providing field values for fields within each component to be used in matching; and
storing the fields, components and values as a general instance of the abstract application.

2. The computer-controlled method of claim 1, wherein classifying the fields comprises marking the fields as at least one of absolute, high-priority, low-priority, or linked.

3. The computer-controlled method of claim 1, wherein providing field descriptors for fields comprises providing values of at least one of default, fixed, or linked.

4. The computer-controlled method of claim 1, wherein providing field descriptor comprises providing field descriptors having field descriptor values to describe treatment of the field values when the general instance is imported.

5. The computer-controlled method of claim 4, wherein providing the field descriptors comprises one of either providing the field descriptors manually or automatically.

6. The computer-controlled method of claim 4, providing the field descriptors comprising providing an importance descriptor to specify importance of the field values in matching.

7. The computer-controlled method of claim 1, the method comprising removing any information used to identify the user or the devices belonging to the user.

8. The computer-controlled method of claim 1, the method comprising sharing the general instance with at least one other user.

9. The computer-controlled method of claim 8, wherein sharing comprises one of e-mailing the general instance, positing the instance on a website, or transferring the instance to a disk, microdrive, Bluetooth transfer, infrared transfer, 802.11x wireless transfer, firewire transfer or Ethernet transfer.

10. The computer-controlled method of claim 1, wherein the general instance includes at least one general instance of a connection.

11. The computer-controlled method of claim 1, wherein the general instance includes at least one designation for a component as one of either optional or required.

12. An apparatus comprising:
an acquisition mechanism to acquire a specific instance of an abstract application of at least one component in a first network;
a generalization mechanism to identify and generalize fields and values associated with the component; and
a store to store the fields, components and values as a general instance of the abstract application.

13. The apparatus of claim 12, wherein the acquisition mechanism comprises one of a creation mechanism, a discovery mechanism, or a reception mechanism.

14. A computer-controlled method to configure a network of devices, comprising:
receiving, at a network, a general instance of an abstract application having fields of at least one component and fields having values;
identifying at least one component in the network having at least one of the fields in the general instance; and
using the fields and values to resolve the general instance into a specific instance of the abstract application in the network.

15. The computer-controlled method of claim 14, wherein receiving further comprises one of receiving the general instance by explicit sharing, implicit sharing, discovery, or downloading.

16. The computer-controlled method of claim 14, wherein identifying comprises automatically determining a best match based on matching fields of the general instance to components of the network.

17. The computer-controlled method of claim 14, wherein identifying comprises prompting a user to select components of the network to which the general instance will apply.

18. The computer-controlled method of claim 14, wherein using the fields and values comprises at least one of overriding default values in the general instance, specifying values for blank values in the general instance, accepting fixed values in the general instance, resolving fields having the value linked such that the field value for both a source and a destination have the same value, resolving fields in an order of importance specified in the fields, and preserving as many default values during resolving the general instance.

19. The computer-controlled method of claim 14, wherein the general instance further comprises a general instance of a connection.

20. The computer-controlled method of claim 14, wherein the general instance includes at least one designation for a component as one of either optional or required.

21. An apparatus, comprising:
a discovery mechanism for discovering a generalized instance of an abstract application, the abstract application having at least one component having fields and the fields having values; and
an importation mechanism to identify a component in the network having at least one of the fields in the general instance and to use the fields and values to resolve the general instance into a specific instance of the abstract application in the network.
